(19) United States
(12) Patent Application Publication
(10) Pub. No.: US 2011/0108301 A1
(43) Pub. Date: May 12, 2011

(54) Handheld power tool

(75) Inventors: Jochen Erhardt, Klosterlechfeld (DE); Matthias Keith, Kaufbeuren (DE); Olaf Koch, Kaufering (DE); Laurent-Sebastian Kock, Poing (DE)

(73) Assignee: Hilti Aktiengesellschaft, Schaan (LI)

(21) Appl. No.: 12/927,055

(22) Filed: Nov. 6, 2010

(30) Foreign Application Priority Data
Nov. 6, 2009 (DE) DE 102009046479.4

(51) Int. Cl. B25D 9/04; B25D 17/06

(52) U.S. Cl. 173/200; 173/133

(57) ABSTRACT

The handheld power tool (10) has a pneumatic striking mechanism (12) that has an exciter element (17), a striking element (17) and an anvil (28). A mechanical spring 8(32) exerts force onto the anvil (26) in the direction opposite from the striking direction (24) of the pneumatic striking mechanism (12).

This claims the benefit of German Patent Application DE 10 2009 046 479.4, filed Nov. 6, 2009 and hereby incorporated by reference herein.

When ground-breaking work is being carried out, a user will frequently lift up the chisel hammer in order to subsequently place it somewhere else. In this process, the user often continues to actuate the operating switch. The motor remains active, driving the striking mechanism. The strikes generated by the striking mechanism cannot be dissipated into the ground via the bit, as a result of which they act on the chisel hammer. In addition to greater wear and tear of the chisel hammer, this also increases the vibration to which the user is exposed.

### BACKGROUND

An object of the present invention is to automatically switch off a striking handheld power tool whenever it is lifted off the ground or a workpiece.

The handheld power tool according to the invention has a pneumatic striking mechanism with an exciter element, a striking element and an anvil. A mechanical spring exerts force onto the anvil in the direction opposite from the striking direction of the pneumatic striking mechanism. The mechanical spring moves the anvil as soon as the user is no longer pressing the handheld power tool against the ground. The distance that the striking element has to travel in order to strike the anvil is increased. Since the striking mechanism is designed for a specific distance, its action is reduced to such an extent that the striking element comes to a standstill in spite of the movement of the exciter element. Therefore, the striking element automatically reduces its striking force or it switches itself off.

One embodiment provides that the anvil is arranged in an anvil guide having a stop on the bit side and a stop on the machine side, and the mechanical spring has a sufficient spring range to move the anvil from the stop on the machine side to the stop on the bit side. The spring moves the anvil from an operating position into a resting position. The resting position of the anvil is offset with respect to the operating position in such a way that the movement of the striking element slows down and comes to a standstill in spite of the movement of the exciter element.

In one embodiment, the anvil runs in an anvil guide having a stop on the machine side, and the exciter piston runs in a striking tube having lateral ventilation openings that are covered by the exciter piston when the latter is resting against the anvil. The anvil rests against the stop on the machine side. The spring range of the mechanical spring is long enough for the mechanical spring to move the anvil in the striking direction to such an extent that, when the exciter piston advances in the striking direction, it exposes the ventilation openings. Once the anvil is in or close to its resting position, the exciter piston can advance further than when the anvil is in the operating position. The ventilation openings are positioned so precisely that normally they are closed by the exciter piston. However, the ventilation openings are exposed as soon as the exciter piston can move further forward in the direction of the bit due to the anvil being in its resting position. Air then flows through the ventilation opening into a pneumatic chamber located between the exciter element and the striking element. The exciter element then draws in air through the exposed openings and consequently exerts little or no suction on the striking element when the exciter element moves back opposite to the striking movement.

One embodiment provides for the spring force of the mechanical spring to be less than 10% of the weight of the handheld power tool. The spring is compressed as soon as a user puts the handheld power tool in place. The anvil goes into its operating position; the striking element is once again excited by the exciter element and strikes the anvil.

### BRIEF DESCRIPTION OF THE DRAWINGS

The description below explains the invention in greater detail on the basis of embodiments and figures by way of examples. The following is shown:

FIG. 1—a handheld power tool.

### DETAILED DESCRIPTION

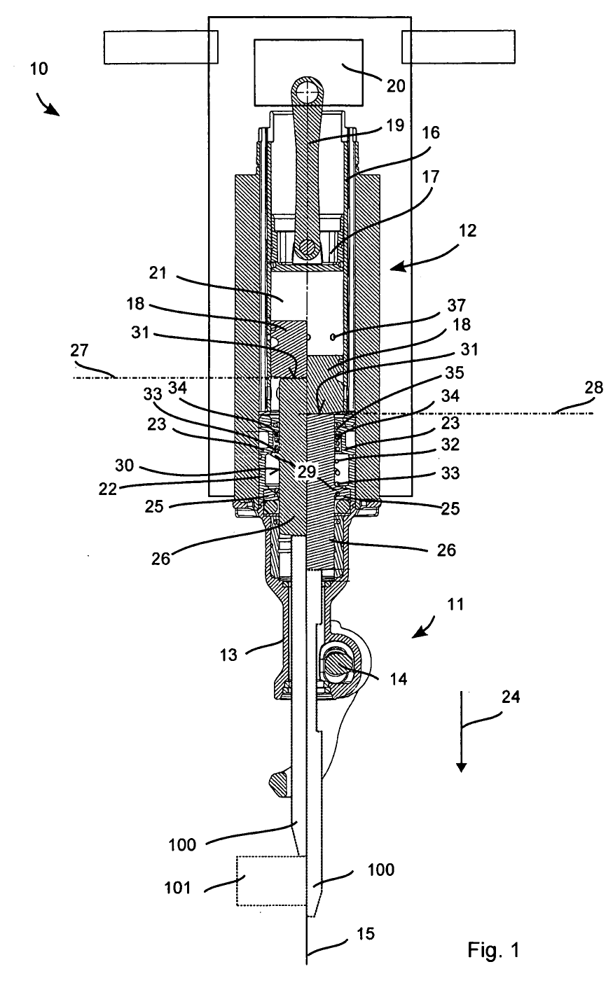

FIG. 1 shows a longitudinal section through a chisel hammer as an example of a striking handheld power tool 10. The handheld power tool can also be suitable for drilling.

The handheld power tool 10 has a tool 11 and a motor-driven pneumatic striking mechanism 12. The tool holder 11 has a bushing 13 to receive the shank of a tool. A locking mechanism 14 serves to lock the bit in the bushing 13, whereby the bit 100 can still be moved axially, along a striking axis 15.

One embodiment of a pneumatic striking mechanism 12 is shown in two positions in FIG. 1. In the left-hand side of FIG. 1, the handheld power tool 10 is standing on the ground 101 via the bit 100, whereas in the right-hand side of FIG. 1, the bit 100 is not touching the ground 101. The striking mechanism 12 has a striking tube 16 in which an exciter element 17 and a striking element 18 can be moved along the striking axis 15. The exciter element 17 is coupled to a motor 20 via a drive train 19. A pneumatic chamber 21 located between the driven exciter element 17 and the striking element 18 couples the striking element 18 to the movement of the exciter element 17.

Adjacent to the striking tube 16, there is an anvil guide 22 having a stop 23 on the machine side as well as a stop 25 on the bit side offset with respect to the stop 23 in the striking direction 24. An anvil 26 can be axially moved in the anvil guide 22 and it is limited between an operating position 27 and a resting position 28. A ring-shaped protuberance 29 on a lengthwise side 30 of the anvil 26 rests against the stop 23 on the machine side when in the operating position 27, and rests against the stop 25 on the bit side when in the resting position 28.

The striking element 18 strikes a face 31 of the anvil 26 on the machine side. The dimensions of the pneumatic striking mechanism 12, the weight of the elements involved and the periodicity of the movement of the exciter element are all configured for a striking point that is defined by the anvil 26 that rests against the stop 23 on the machine side. While the handheld power tool 1 is being used, the bit is pressed against the ground or against a workpiece. The pressing force causes the bit and the anvil 26 to be moved into the operating position 27 opposite from the striking direction 24, that is to say, until the anvil 26 comes to rest against the stop 23 on the machine side.

A coil spring 32, with its end 33 on the machine side, is placed on the protuberance 29. The axis of the coil spring 32 is oriented parallel to the striking axis 15 of the handheld power tool 10. The coil spring 32 can be arranged, for instance, concentrically to the anvil 26. The coil spring 32, with its end 34 that is on the machine side, rests against a contact point 35 of the anvil guide 22. The coil spring 32 exerts a force on the anvil 26 in the direction of the bit 100. The coil spring 32 is tensioned when the anvil 26 rests against the stop 23 of the anvil guide 22 on the machine side. Thus, the coil spring 32 presses the anvil 26 out of its operating position 27. The coil spring 32 can move the anvil 26 forward all the way to the stop 25 on the bit side.

Radial ventilation openings 37 have been made in the striking tube 16. These ventilation openings 37 are covered by the striking mechanism 18 when the anvil 26 is resting against the stop 23 on the machine side. Otherwise, when the anvil 26 has advanced in the striking direction 24, for example, because of the coil spring 32, the striking element 18 can advance in the striking direction 24 beyond the ventilation openings 37. The pressure in the pneumatic chamber 21 adapts to the ambient pressure owing to the ventilation openings 37. The transmission of force from the exciter element 17 to the striking element 18 is interrupted.

The spring force of the coil spring 32 is much smaller than the usual contact pressure exerted by the bit 100 onto the ground 101. As soon as the user places the handheld power tool 10 with the bit onto the ground, the coil spring 32 is compressed to such an extent that the anvil 26 comes to rest against the stop 23 of the anvil guide 22 on the machine side, that is to say, in the operating position 27. The spring force of the coil spring 32 amounts to, for example, less than 10% of the force exerted by the weight of the handheld power tool 10. However, the spring force is dimensioned so as to be sufficient to move the anvil 26 and a bit 100 resting on the anvil 26 against the friction forces in the striking direction 24.

The pneumatic striking mechanism 12 is only shown by way of an example. Instead of being piston-like, the exciter element 17 can also be pot-shaped so as to extend laterally around the striking element 18. As an alternative, the striking element 18 can be pot-shaped so as to extend laterally around the exciter element 17.

Instead of a coil spring 32, it is also possible for a leaf spring to move the anvil 26 between the operating position and the resting position.

What is claimed is:

1. A handheld power tool comprising:
a pneumatic striking mechanism having an exciter element, a striking element and an anvil, the pneumatic striking mechanism having a striking direction; and
a mechanical spring exerting force onto the anvil in a direction opposite the striking direction.

2. The handheld power tool as recited in claim 1 having a machine side and a bit side, and further comprising an anvil guide, the anvil being arranged in the anvil guide having a stop on the bit side and a stop on the machine side, and the mechanical spring having a sufficient spring range to move the anvil from the stop on the machine side to the stop on the bit side.

3. The handheld power tool as recited in claim 1 having a machine side and a bit side, and further comprising an anvil guide and a striking tube, the anvil running in the anvil guide, the anvil guide having a stop on the machine side, the exciter element being an exciter piston running in the striking tube, the striking tube having lateral ventilation openings covered by the exciter piston when the exciter piston is resting against the anvil and the anvil rests against the stop on the machine side, a spring range of the mechanical spring being long enough for the mechanical spring to move the anvil in the striking direction to such an extent that, when the exciter piston advances in the striking direction, the ventilation openings are uncovered.

4. The handheld power tool as recited in claim 1 wherein the spring force of the mechanical spring is less than 10% of the weight of the handheld power tool.

5. The handheld power tool as recited in claim 2 wherein the spring force of the mechanical spring is less than 10% of the weight of the handheld power tool.

6. The handheld power tool as recited in claim 3 wherein the spring force of the mechanical spring is less than 10% of the weight of the handheld power tool.
